(19) United States
(12) Patent Application Publication
(10) Pub. No.: US 2010/0244773 A1
(43) Pub. Date: Sep. 30, 2010

(54) UNITY POWER FACTOR ISOLATED SINGLE PHASE MATRIX CONVERTER BATTERY CHARGER

(75) Inventor: LATEEF A. KAJOUKE, SAN PEDRO, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/413,181

(22) Filed: Mar. 27, 2009

(51) Int. Cl. H02J 7/04

(52) U.S. Cl. 320/137

(57) ABSTRACT

Apparatus for unity power factor, isolated, single phase switch matrix converter/battery charger is provided. In one implementation, An AC grid voltage source is coupled to and inductor and a switching matrix. The inductor is charged and the switching matrix is controlled to crate various current paths for the voltage across the inductor to add to the AC grid voltage. The boosted AC grid voltage flow across an isolation transformer to be rectified and used to charge a battery matrix for an electric powered vehicle.

### TECHNICAL FIELD

The present invention generally relates to battery charging and more particularly relates to charging batteries from a single phase power source and achieving a unity power factor for the charging process.

### BACKGROUND OF THE INVENTION

The electrical design of electric vehicle and hybrid vehicle charging system poses numbers of challenges. For example, selection of power topologies, delivery of high power over wide range of operating input/output voltages, galvanic isolation, high power density and low cost. The battery base Energy Storage System (ESS) voltage characteristics and the number of the power grid voltage phases drive the output/input requirements of the charging system.

Ideally, a charging system should achieve a unity power factor and low total harmonic distortion, galvanic isolated power state and high power density. In an attempt to meet these goals, contemporary charging systems employ a two state design. The first stage includes a wide input voltage range unity power factor boost converter that provides an output voltage higher than the ESS maximum specified voltage. The second stage provides galvanic isolation and processes the voltage and current to the ESS as specified by the charging control system.

The drawbacks of this contemporary practice are that the two stages are inefficient because a power boost stage is required to generate an intermittent high voltage direct current bus. Moreover, in the case of high power or rapid charging, the front end of the two stage system requires a multiphase power grid connection (e.g., two-phase or three-phase). However, in the United States, most homes and businesses operate from a standard (110 volt, 60 Hz in the United States) single phase power grid voltage.

Accordingly, it is desirable to provide a single phase charging system that achieves an efficiency of a unity power factor while providing the isolation, low harmonic distortion and high power density needed for hybrid vehicles, electric vehicles or charging applications requiring similar charging performance. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

Embodiments of the present invention relate to a unity power factor, isolated, single phase switch matrix converter/battery charger is provided. In one implementation, An AC grid voltage source is coupled to and inductor and a switching matrix. The inductor is charged and the switching matrix is controlled to crate various current paths for the voltage across the inductor to add to the AC grid voltage. The boosted AC grid voltage flow across an isolation transformer to be rectified and used to charge a battery storage system for an electric powered or hybrid powered vehicle.

### DESCRIPTION OF THE DRAWINGS

The present invention will hereinafter be described in conjunction with the following drawing figures, wherein like numerals denote like elements, and

FIG. 1 is an electrical schematic diagram of a charging system according to the prior art;

FIG. 2 is an electrical schematic diagram of a charging system according to one embodiment of the present invention;

FIG. 3 is a timing diagram for control of the switches of FIG. 2 in accordance with the present invention;

FIG. 4 is an equivalent electrical schematic diagram of a the switching arrangement of the present invention during an initial stage of operation;

FIG. 5 is a timing diagram of the sinusoidal pulse width modulated (PWM) variable duty cycle control signal D(t) of the present invention.

FIGS. 6A and 6B are equivalent electrical schematic diagrams of the switching arrangement of the present invention during a positive phase of the AC grid current according to one embodiment of the present invention.

FIGS. 7A and 7B are equivalent electrical schematic diagrams of the switching arrangement of the present invention during a negative phase of the AC grid current according to one embodiment of the present invention.

FIG. 8 is a block diagram of the control circuit to generate the sinusoidal pulse width modulated (PWM) variable duty cycle control signal D(t) according to one embodiment of the present invention.

FIG. 9 is a waveform diagram illustrating the converter output voltage and in-phase AC grid voltage and grid current to achieve a unity power factor in the present invention.

### DESCRIPTION OF AN EXEMPLARY EMBODIMENT

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary or the following detailed description.

In this regard, any of the concepts disclosed here can be applied generally to electric or hybrid “vehicles,” and as used herein, the term “vehicle” broadly refers to a non-living transport mechanism Examples of such vehicles include automobiles such as buses, cars, trucks, sport utility vehicles, vans, and mechanical rail vehicles such as trains, trams and trolleys, etc. In addition, the term “vehicle” is not limited by any specific propulsion technology such as gasoline, diesel, hydrogen or various other alternative fuels.

Exemplary Implementations

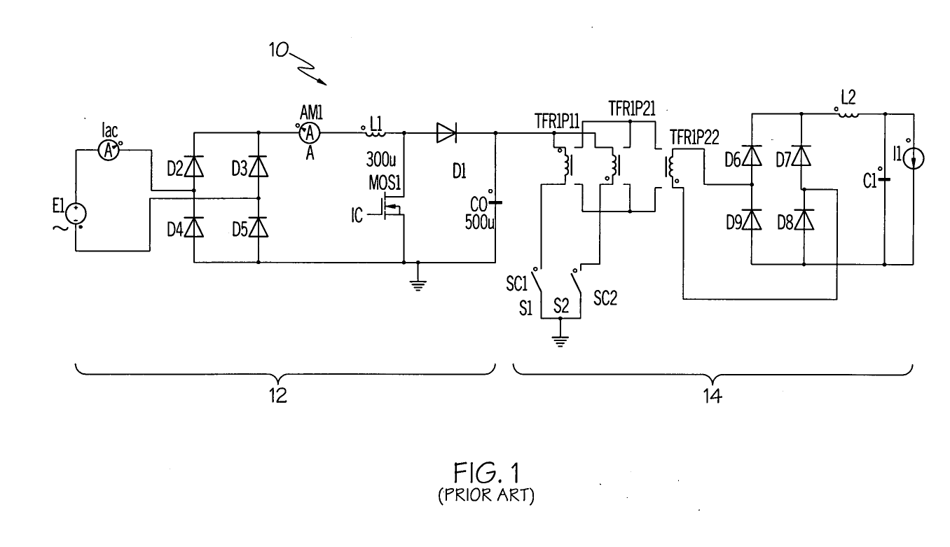

Referring now to FIG. 1, a charging system 10 in accordance with the prior art is shown. The first stage 12 includes a wide input voltage range unity power factor boost converter that provides an output voltage higher than the battery base Energy Storage System ESS maximum specified voltage. The second stage 14 provides galvanic isolation and processes the voltage and current to the ESS as specified by the charging control system (not shown).

The drawbacks of the charging system 10 are that the two stages are inefficient because a power boost stage is required to generate an intermittent high voltage direct current bus. Moreover, in the case of high power or rapid charging, the first stage 12 of the two stage charging system 10 requires a multiphase power grid connection (e.g., two-phase or three-phase).

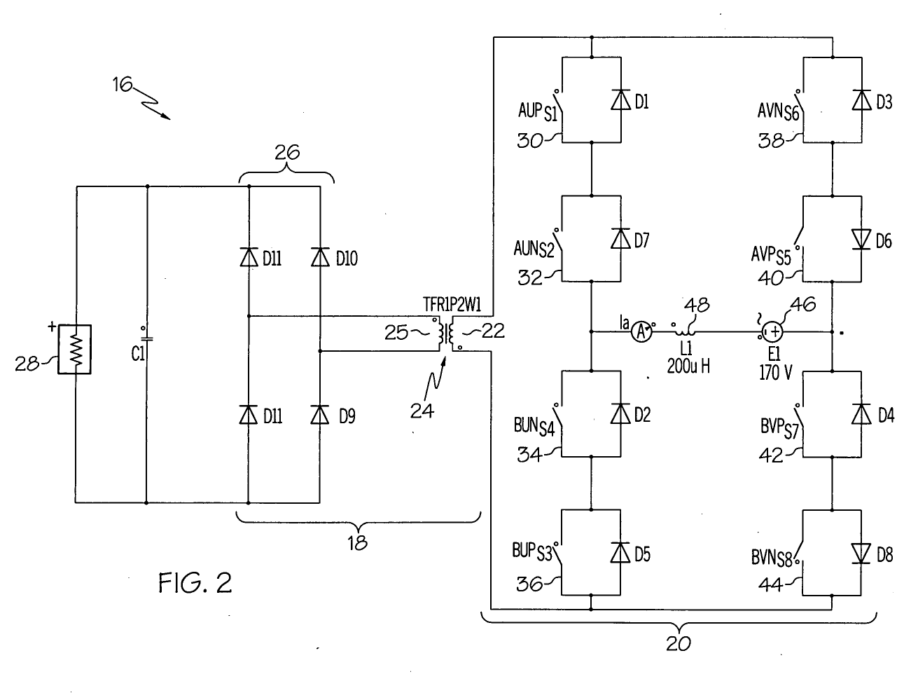

Referring now to FIG. 2, a single stage charging system 16 in accordance with one embodiment of the present invention is shown. The charging system 16 consists of high frequency link 18 and a matrix converter 20. The high frequency link 18 is mechanized by high frequency isolation transformer 24 and full bridge chopper/rectifier 26. The high frequency isolation transformer 24 provides galvanic isolation between the 28 and the matrix converter 20.

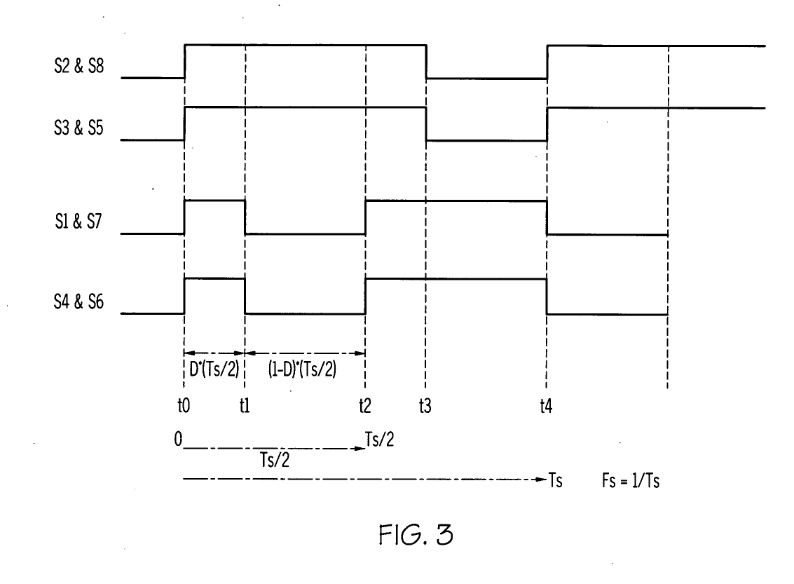

The matrix converter 20 contains bi-directional switches 30-44 that are grouped into two groups: Positive (P) (bi-directional switches 30, 36, 40 and 42) and negative (N) (bi-directional switches 32, 34, 38 and 44). The selection of group P or N is determined by the direction of the AC input current from the power grid voltage 46. The switching action of the bi-directional switches 30-44 are controlled by state machine fashion that will be discussed in conjunction with FIGS. 3-7.

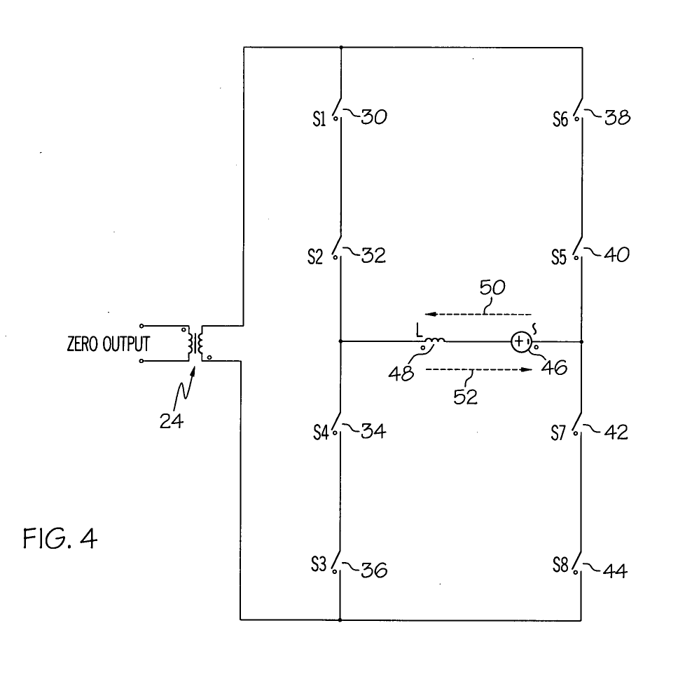

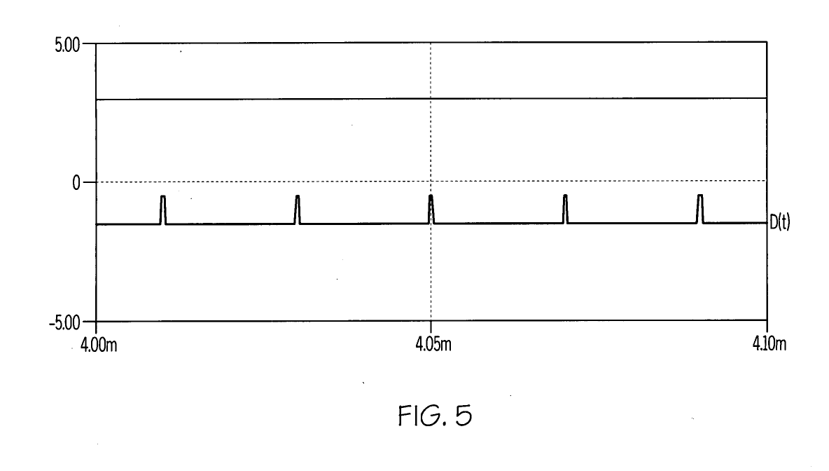

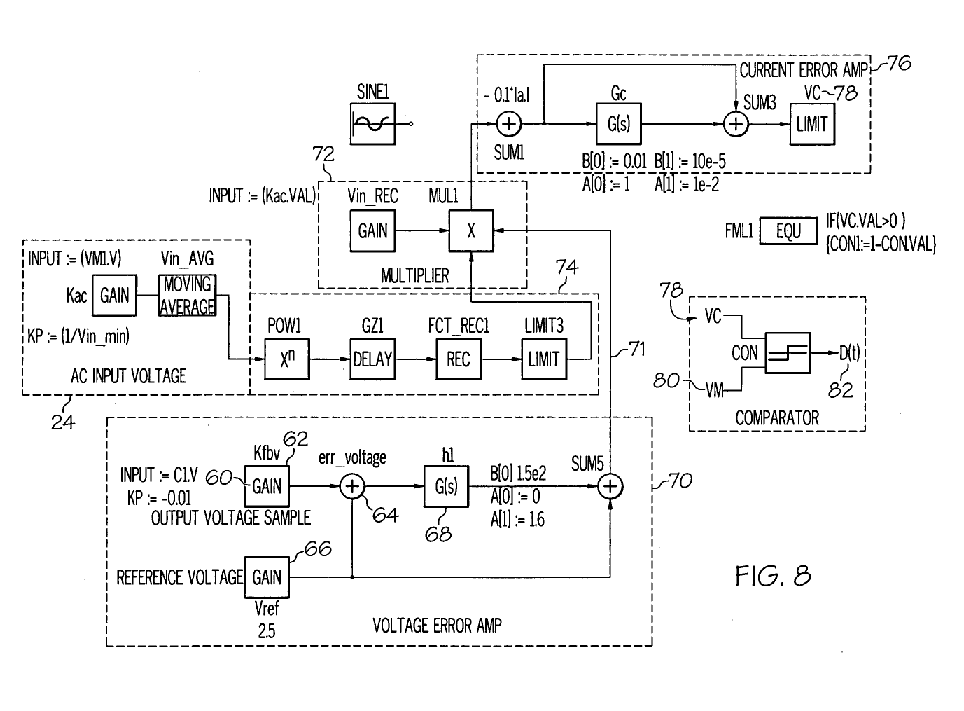

Referring now to FIG. 3, a timing diagram is shown for one embodiment of the switches S1-S8 (30-44). An initial converter cycle of operation starts at t₀ and end at t₄. The initial converter cycle is useful as the grid AC current polarity (50 or 52) is unknown at t₀. Accordingly, at t₀ switches S1, S2, S3, S4, S5, S6, S7 and S8 are turned ON (closed) for time interval equal to D(t)*(Ts/2/)μsec as shown in the timing diagram of FIG. 3 and the circuit diagram FIG. 4, where D(t) is a sinusoidal modulated variable duty cycle as illustrated in FIG. 5, which is generated by the control circuitry to be discussed in conjunction with FIG. 8. As can be seen in FIG. 4, with all switches ON (closed), the input phase current is circulated in the networks formed by the input inductor and switches, resulting in no output voltage across the transformer 24. However, the closed switching action forces the AC grid voltage across the boost inductor L (48) and energy is stored in the boost inductor 48 regardless of the grid AC current polarity at to.

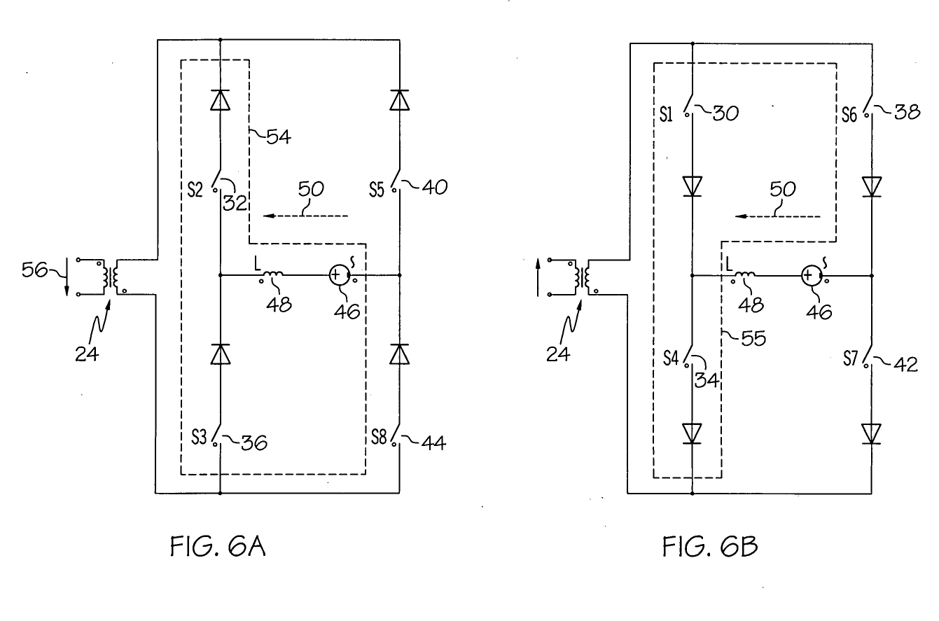

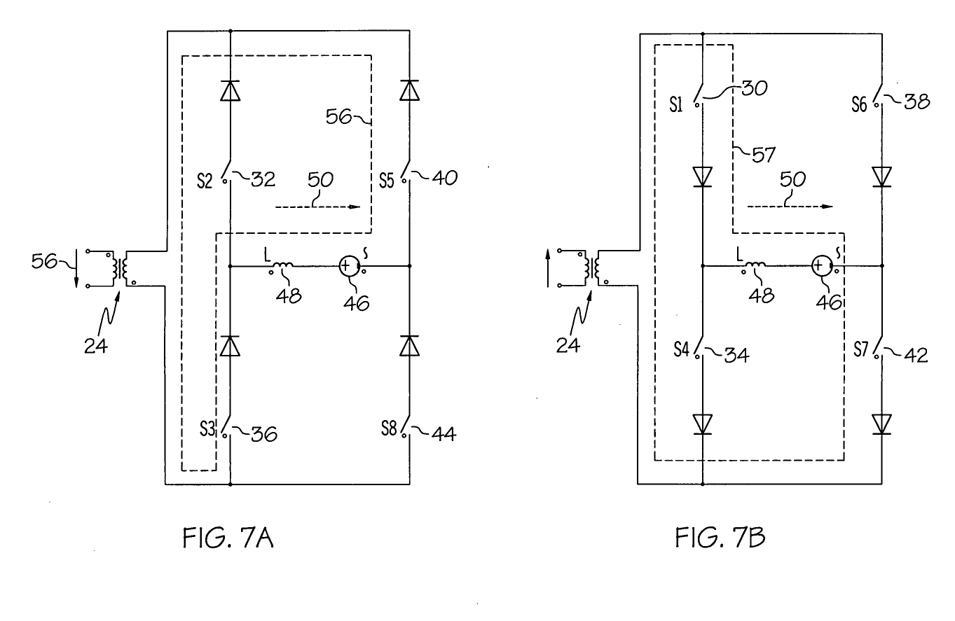

Referring again to FIG. 3, at t₁, switches S1, S7, S4 and S6 are turned OFF (open), while switches S2, S3, S5 and S8 remain ON, as shown in FIG. 6A and FIG. 7A, for a time interval equal to {1−D (t)}*(Ts/2)μsec. This switching operation releases the energy stored in the boost inductor 48 and generates a fly-back voltage. The fly-back voltage is added to the instantaneous value of the grid AC voltage 50. With switches S2, S3, S5 and S8 ON, this switching configuration provides a conductivity path (or 56 depending upon the polarity of the AC grid voltage 46) for energy from the grid and energy stored in the boost inductor to flow to the output terminals of the converter via the isolation transformer 24 regardless of the grid AC current polarity (50 or 52) and generate a boosted voltage, Vtx (56), across the isolation transformer 24.

Where, Vtx=VAC/{(1−D(t)} and for a duration equal to {1−D (t)}*(Ts/2)μsec.

At time t₂, switches S1, S2, S3, S4, S5, S6, S7 and S8 are again turned ON (FIG. 4) and the AC grid voltage 24 is again forced across the boost inductor 48 and energy is stored in the boost inductor for a time interval equal to D(t)*(Ts/2/)μsec.

Referring again to FIG. 3, at t₃, switches S2, S3, S5 and S8 are turned OFF (open), while switches S1, S4, S6 and S7 remain ON, as shown in FIG. 6B and FIG. 7B, for a time interval equal to {1−D(t)}*(Ts/2)μsec. This switching operation releases the energy stored in the boost inductor 48 and generates a fly-back voltage. The fly-back voltage is added to the instantaneous value of the grid AC voltage 48. With switches S1, S4, S6 and S7 ON, this switching configuration provides a conductivity path 55 (or 57 depending upon the polarity of the AC grid voltage 46) for energy from the grid and energy stored in the boost inductor to flow to the output terminals of the converter via the isolation transformer 24 regardless of the grid AC current polarity (50 or 52) and generate a boosted voltage, Vtx (56), across the isolation transformer 24.

Where, Vtx=VAC/{(1−D(t)} and for a duration equal to {1−D (t)}*(Ts/2)μsec.

The initial converter cycles between t₀ and t₄ give the present invention the advantage of being able to start up without prior knowledge of the grid AC current polarity. Accordingly, the present invention continues as cycle of repeating between the states of switches S2, S3, S5 and S8 being ON, as shown in FIG. 6A and FIG. 7A, and switches S1, S4, S6 and S7 remain ON, as shown in FIG. 6B and FIG. 7B, each for a switching time Ts and switching frequency equal to Fs=1/Ts.

Referring now to FIG. 8, the control circuit for generating the sinusoidal pulse width modulated (PWM) variable duty cycle control signal D(t) is shown in block diagram form. The output voltage is sampled and the sample 60 is amplified 62 and compared 64 with a reference voltage 66 using the voltage error amplifier 68, the output 71 of the error amplifier 70 is applied to multiplier 72, and the AC grid voltage is processed and the reciprocal of the AC voltage 24 is applied to the multiplier 72 at output 74. The output of the multiplier 72 is applied to the current error amplifier 76 and the inductor current is sampled and fed to the current error amplifier. The output of the current error amplifier, VC (78), is compared with high frequency carrier, VM (80). In one preferred embodiment, VM comprises a 50 kHz signal. The output of the comparator is the converter sinusoidal PWM modulated duty cycle D(t) 82, which is illustrated in FIG. 5. As discussed in conjunction with FIGS. 3-7, the D(t) signal controls the ON/OFF time interval of the switches S1-S8.

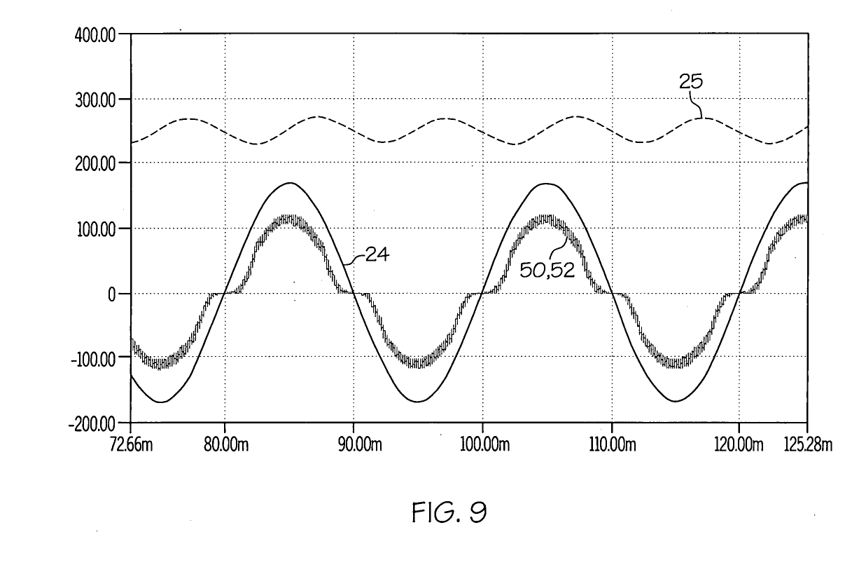

The switching the converter of the present invention with a sinusoidal modulated duty cycle, D(t) produces unity power factor charging operation and yielding a low Total Harmonic Distortion (THD) as shown in FIG. 9. The AC grid input voltage 24 is in-phase with the grid input current (50 or 52, depending on polarity). This results in a unity power factor in a single stage power converter. The AC grid voltage added to the boost voltage from the inductor 48 provides a charging voltage 25 of approximately 250 volts with low ac input voltage THD.

Some of the embodiments and implementations are described above in terms of functional and/or logical block components and various processing steps. However, it should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

In this document, relational terms such as first and second, and the like may be used solely to distinguish one entity or action from another entity or action without necessarily requiring or implying any actual such relationship or order between such entities or actions. Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for converting an AC grid voltage to a DC charging voltage, comprising the steps of:
coupling an inductor to the AC grid voltage and a single stage switch matrix;
controlling the single stage switch matrix to charge the inductor with a voltage;
controlling the single stage switch matrix to provide a first and second current path for the voltage and the AC grid voltage to flow across an isolation transformer, the first and second current path being responsive to AC grid current polarity;
repeating controlling the single stage switch matrix to charge the inductor with a voltage;
controlling the single stage switch matrix to provide a third and fourth current path for the voltage and the AC grid voltage to flow across an input to an isolation transformer, the third and fourth current path being responsive to AC grid current polarity;
rectifying the voltage and the AC grid voltage from an output of the isolation transformer to provide a charging voltage.

2. The method of claim 1, where the step of controlling the single stage switch matrix to charge the inductor with a voltage comprises closing eight switches arranged in a four by four parallel switch configuration for a first time period.

3. The method of claim 1, where the step of controlling the single stage switch matrix to provide a first and second current path comprises opening the first and third switches on each side of the four by four parallel switch configuration for a second time period.

4. The method of claim 1, where the step of controlling the single stage switch matrix to provide a third and fourth current path comprises opening the second and fourth switches on each side of the four by four parallel switch configuration for the second time period.

5. A single phase isolated switch converter battery charger, comprising:
an AC grid voltage source providing an AC grid voltage;
an inductor in series with the AC grid power source;
a single phase switch matrix;
a controller for controlling the single phase switch matrix to open or close switches to create current paths;
an isolation transformer coupled at in input side to the single phase switch matrix; and
a rectifier coupled to an output side of the isolation transformer;
whereby, the controller controls the single phase switch matrix to charge the inductor with a voltage, and then control the switches to create current paths for the voltage and the AC grid voltage to pass across the isolation transformer to the rectifier to charge a battery.

6. The single phase isolated switch converter battery charger of claim 5, wherein the single phase switch matrix comprises eight switches arranged in a four by four parallel configuration.

7. The single phase isolated switch converter battery charger of claim 5, wherein the controller opens and closes the switches to achieve a substantially unity power factor.

8. The single phase isolated switch converter battery charger of claim 5, wherein the controller achieves a low input AC total harmonic distortion.

9. A single phase isolated switch converter battery charger, comprising:
an AC grid voltage source providing an AC grid voltage;
an inductor in series with the AC grid power source;
a single phase switch matrix comprising eight switches arranged in a four by four parallel configuration;
a controller for controlling the single phase switch matrix to open or close the switches to create current paths;
an isolation transformer coupled at in input side to the single phase switch matrix; and
a rectifier coupled to an output side of the isolation transformer;
whereby, the controller controls the single phase switch matrix to charge the inductor with a voltage, and then control the switches to create current paths for the voltage and the AC grid voltage to pass across the isolation transformer to the rectifier to charge a battery.

10. The single phase isolated switch converter battery charger of claim 9, wherein the controller opens and closes the switches to achieve a substantially unity power factor.

11. The single phase isolated switch converter battery charger of claim 9, wherein the controller achieves a low input AC total harmonic distortion.
